(19) United States
(12) Patent Application Publication
(10) Pub. No.: US 2009/0312007 A1
(43) Pub. Date: Dec. 17, 2009

(54) RE-ESTABLISHMENT OF A RLC ENTITY

(75) Inventors: Tommi Kallio, Oulu (FI); Mika Kaukoranta, Oulu (FI); Antti Tormanen, Oulu (FI); Tero Miettinen, Oulu (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/408,692

(22) Filed: Mar. 21, 2009

Related U.S. Application Data
(60) Provisional application No. 61/038,518, filed on Mar. 21, 2008.

(51) Int. Cl. H04W 76/04

(52) U.S. Cl. 455/422.1

(57) ABSTRACT

According to one general aspect, a method of re-establishing a radio link control (RLC) connection between a peer entity and another peer entity in a wireless network is described herein. The method may include determining the occurrence of an RLC error condition. Subsequently, transmitting a RLC re-establishment request to the other peer entity. Delaying the completion of the RLC re-establishment process for a period of time. And, completing the RLC re-establishment process.

### RELATED APPLICATION

This patent application claims priority to U.S. Provisional Application No. 61/038,518, filed Mar. 21, 2008, the disclosure of which is incorporated by reference herein in its entirety.

### TECHNICAL FIELD

This description relates to wireless networks.

### BACKGROUND

Typically, wireless networks include a base station that generally couples a wired network with a wireless network and mobile station that uses the wireless network. Often these two devices are in direct communication. Frequently, these devices use multiple logical or physical channels to communicate information. Due to the mobile nature of the devices, the protocols operating on the devices frequently need to handle adverse conditions. Often a technique for handling adverse communications conditions includes resetting or re-establishing the communications channel between the two devices.

Universal Mobile Telecommunications System (UMTS) is one of the third-generation (3G) cell phone technologies and employs base stations and mobile stations. Such a system may carry many traffic types. Some examples may include real-time Circuit Switched data (e.g., voice data) or IP based Packet Switched data (e.g., web data). In some embodiments, the radio access network (RAN) part of the UMTS is known as UTRAN (Universal Terrestrial Radio Access Network) or Evolved UTRAN (E-UTRAN).

### SUMMARY

According to one general aspect, a method of re-establishing a radio link control (RLC) connection between a peer entity and another peer entity in a wireless network is described herein. The method may include determining the occurrence of an RLC error condition. Subsequently, transmitting a RLC re-establishment request to the other peer entity. Delaying the completion of the RLC re-establishment process for a period of time. And, completing the RLC re-establishment process.

According to another general aspect, a method of re-establishing a radio link control (RLC) connection between a peer entity and another peer entity is described herein. The method may include determining, by a peer entity, the occurrence of an RLC error condition, and preventing the transmission of data between the two peer entities until a RLC re-establishment is complete.

According to another general aspect, an apparatus is described herein. The apparatus may include a controller configured to determine that a RLC re-establishment with a peer entity is desirable. The apparatus may also include a wireless transceiver configured to transmit a RLC re-establishment request to the peer entity. The controller may be further configured to delay completion of the RLC re-establishment process for a period of time, and complete the RLC re-establishment process.

According to another general aspect, an apparatus is described herein. The apparatus may include a peer entity configured to communicate data with another peer entity. The apparatus may also include a controller configured to determine that a RLC re-establishment between the peer entity and the other peer entity is desirable, and prevent the transmission of data between the peer entity and the other peer entity until the RLC re-establishment is complete. The apparatus may also include a transceiver configured to transmit data between the peer entity and the other peer entity, and request the RLC re-establishment between the peer entity and the other peer entity.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a wireless network in accordance with an example embodiment of the disclosed subject matter.

FIG. 2 is a block diagram of a wireless device in accordance with an example embodiment of the disclosed subject matter.

FIG. 3 is a block diagram of a wireless device in accordance with an example embodiment of the disclosed subject matter.

FIG. 4 is a timing diagram of a wireless network in accordance with an example embodiment of the disclosed subject matter.

FIG. 5 is a timing diagram of a wireless network in accordance with an example embodiment of the disclosed subject matter.

FIG. 6 is a timing diagram of a wireless network in accordance with an example embodiment of the disclosed subject matter.

FIG. 7 is a timing diagram of a wireless network in accordance with an example embodiment of the disclosed subject matter.

FIG. 8 is a timing diagram of a wireless network in accordance with an example embodiment of the disclosed subject matter.

FIG. 9 is a block diagram of a wireless device in accordance with an example embodiment of the disclosed subject matter.

FIG. 10 is a flowchart of a technique in accordance with an example embodiment of the disclosed subject matter.

FIG. 11 is a flowchart of a technique in accordance with an example embodiment of the disclosed subject matter.

### DETAILED DESCRIPTION

Referring to the Figures in which like numerals indicate like elements,

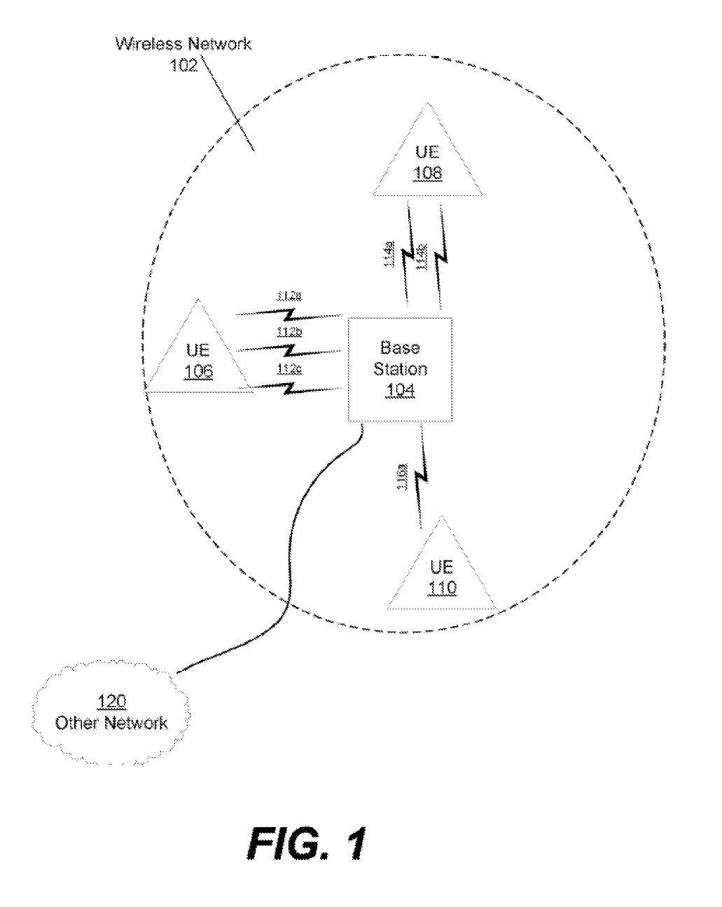

FIG. 1 is a block diagram of a wireless network 102 including a base station (BS) 104 and mobile stations or user equipment (UE) 106, 108, 110, according to an example embodiment. Each of the UEs 106, 108, 110 may be associated with BS 104, and may transmit data in an uplink direction to BS 104, and may receive data in a downlink direction from BS 104, for example. Although only one BS 104 and three mobile stations (UEs 106, 108 and 110) are shown, any number of base stations and mobile stations may be provided in network 102. Also, although not shown, mobile stations 106, 108 and 110 may be coupled to base station 104 via relay stations or relay nodes, for example. The base station 104 may be connected via wired or wireless links to another network 120, such as a Local Area Network, a Wide Area Network (WAN), the Internet, etc. In various embodiments, the base station 104 may be coupled or connected with the other network 120 via an access network controller or gateway (not shown) that may control, monitor, or limit access to the other network.

In one embodiment, the BS 104 may be in communication with the UEs via logical communication channels known as “radio bearers” (e.g., radio bearer 116a). In various embodiments, each radio bearer may be mapped to a pair of peer entities: one peer entity in the UE, one peer entity in the BS. In various embodiments, each device may include multiple peer entities. For example, BS 104 and UE 110 may include one peer entity pair. BS 104 and UE 108 may include two peer entity pairs (using radio bearers 114a and 114b), such that UE 108 includes two peer entities. BS 104 and UE 106 may include three peer entity pairs (using radio bearers 112a, 112b, and 112c), such that UE 106 includes three peer entities. As a result, BS 104 may include six peer entities: three connected with UE 106, two connected with UE 108 and one connected with UE 110. These peer entities pairs may operate mostly independently. For example, in one embodiment, if an error occurs involving the peer entities associated with radio bearer 112a it may be possible for the peer entities associated with radio bearers 112b and 112c to continue operation. The operations of the peer entities are described in further detail below.

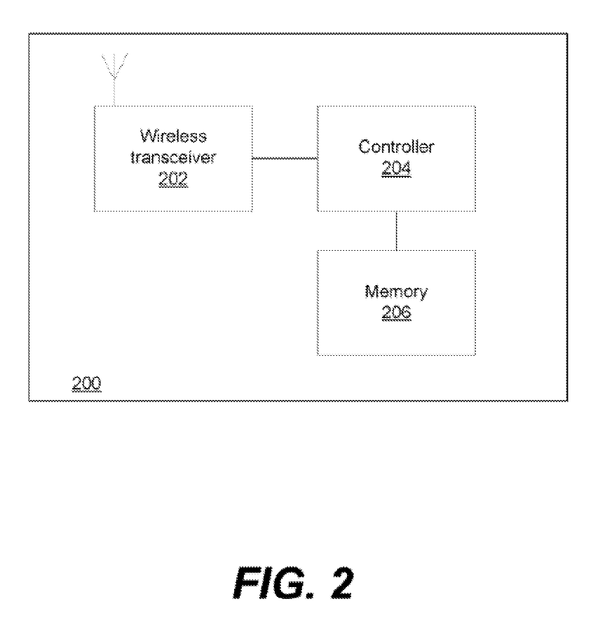

FIG. 2 is a block diagram of a wireless device 200 in accordance with an example embodiment of the disclosed subject matter. In one embodiment, the wireless device 200 may include a user equipment (UE) or mobile station such as those illustrated in FIG. 1. In another embodiment, the wireless device 200 may include a base station such as that illustrated in FIG. 1. In one embodiment, the wireless device 200 may include a wireless transceiver 202, a controller 204, and a memory 206. In various embodiments, the controller 204 may include a processor. For example, some operations illustrated and/or described herein, may be performed by a controller 204, under control of software or firmware.

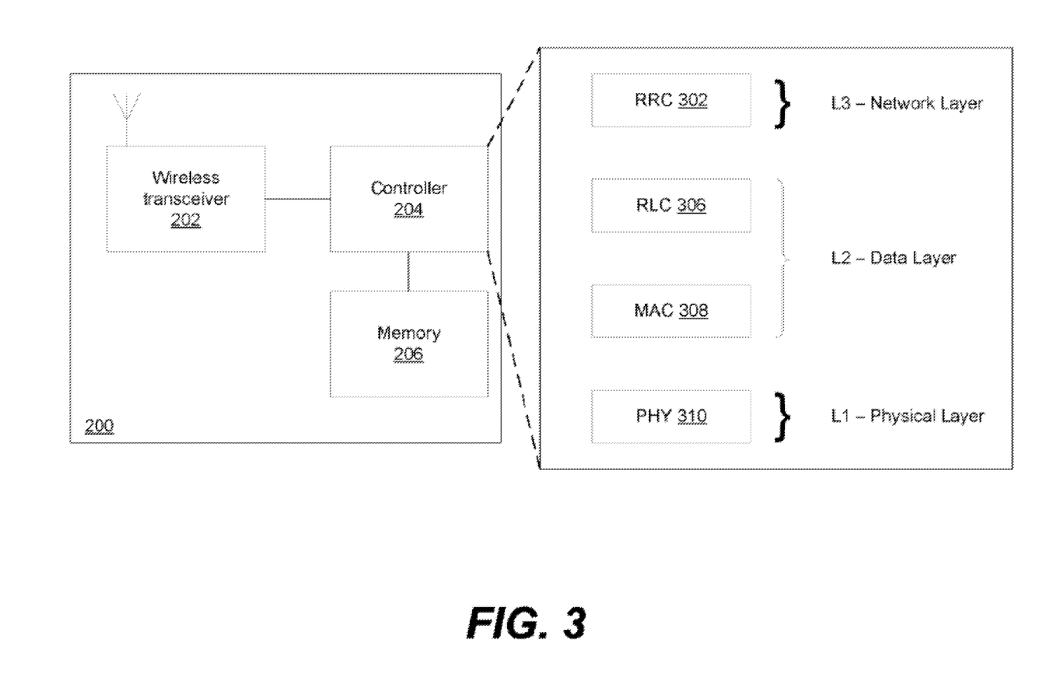

FIG. 3 is a block diagram of a wireless device 200 in accordance with an example embodiment of the disclosed subject matter. FIG. 3 illustrates that the controller may create and control a series of logical networking layers and sub-layers used in wireless communication. Understanding of a portion of these layers may be needed in the explanation of the disclosed subject matter and the relationship of peer entities to one another.

The Open Systems Interconnection Basic Reference Model (OSI Model) is a commonly used layered, abstract description for communications and computer network protocol design. A layer, in this context, may include a collection of related functions that provide services to the layer above it and receives service from the layer below it. For example, a layer that provides error-free communications across a network provides the path needed by applications above it, while it uses the next lower layer to send and receive packets that make up the contents of the path. The layers, therefore, are hierarchal and each layer provides a greater level of abstraction from the layer below. From top to bottom, the OSI Model consists of the Application, Presentation, Session, Transport, Network, Data Link, and Physical layers.

Of immediate interest are the lower three layers of the OSI Model: the network layer, the data layer, and the physical layer. In the OSI Model, the Network layer (L3) generally performs network routing functions. In the OSI model the Data layer or Data Link layer (L2), generally provides the functional and procedural means to transfer data between network entities (e.g., peer entities) and to detect and possibly correct errors that may occur in the physical layer. In the OSI model, the Physical layer (L1) defines the relationship between a device and a physical medium. In various embodiments, the transceiver 202 may manage or control the physical layer (PHY) 310.

In one embodiment, the controller 204 may control a sub-layer in the network layer known as the Radio Resource Control (RRC) sub-layer 302. In various embodiments, the Radio Resource Control (RRC) sub-layer 302 may be included in the Universal Mobile Telecommunications System (UMTS) protocol and more specifically the Evolved Universal Terrestrial Radio Access Network (E-UTRAN) protocol, its predecessors and/or derivatives (hereafter, “the E-UTRAN standard”). Universal Mobile Telecommunications System (UMTS); Evolved Universal Terrestrial Radio Access (E-UTRA) and Evolved Universal Terrestrial Radio Access (E-UTRAN); Overall description; Stage 2, 3GPP TS 36.300 version 8.2.0 Release 8, October 2007.

The RRC sub-layer 302 may, in one embodiment, handle the control signaling of the Network layer between the UEs and other UTRAN devices (e.g., a base station or in EUTRAN parlance, “EUTRAN Node B (eNB)”). The RRC sub-layer 302 may also, in one embodiment, perform functions for connection establishment and release, broadcast of system information, Radio Bearer establishment, reconfiguration and releases, RRC Connection mobility procedures, paging notification and release, outer loop power control, etc. As a higher network layer, the RRC sub-layer 302 may, in one embodiment, control or be associated with any lower network layers (e.g., the data layer). In various embodiments, the RRC sub-layer 302 or RRC sub-layer instantiations may create or reset any lower network layers associated with the RRC sub-layer 302.

In one embodiment, the controller 204 may control at least two sub-layers in the data layer. These two sub-layers may include the Radio Link Control (RLC) sub-layer or protocol 306 and the Medium Access Control (MAC) sub-layer or protocol 308. In one embodiment, the RLC 306 sub-layer may control the flow and error control of data between peer entities. The MAC 308 sub-layer may, in one embodiment, provide addressing and channel access control mechanisms that make it possible for the network nodes (e.g., UEs and BSs) to communicate within the network.

In one embodiment, each radio bearer may be mapped, in the RLC sub-layer 306, to a RLC entity (a.k.a. peer entity or RLC peer entity). For example, the radio bearer 112a of FIG. 1 may be mapped to a RLC or peer entity in UE 106 and a RLC or peer entity in BS 104. In such an embodiment, each RLC peer entity in an UE may have a corresponding RLC peer entity in the BS. In one embodiment, the RLC sub-layer 306 may package data into RLC Protocol Data Units (PDUs). These PDUs may be used to deliver data between RLC peer entities. In one embodiment, the PDUs may be assigned a sequence number (SN) that uniquely identifies the PDU within a certain transmission window or time frame.

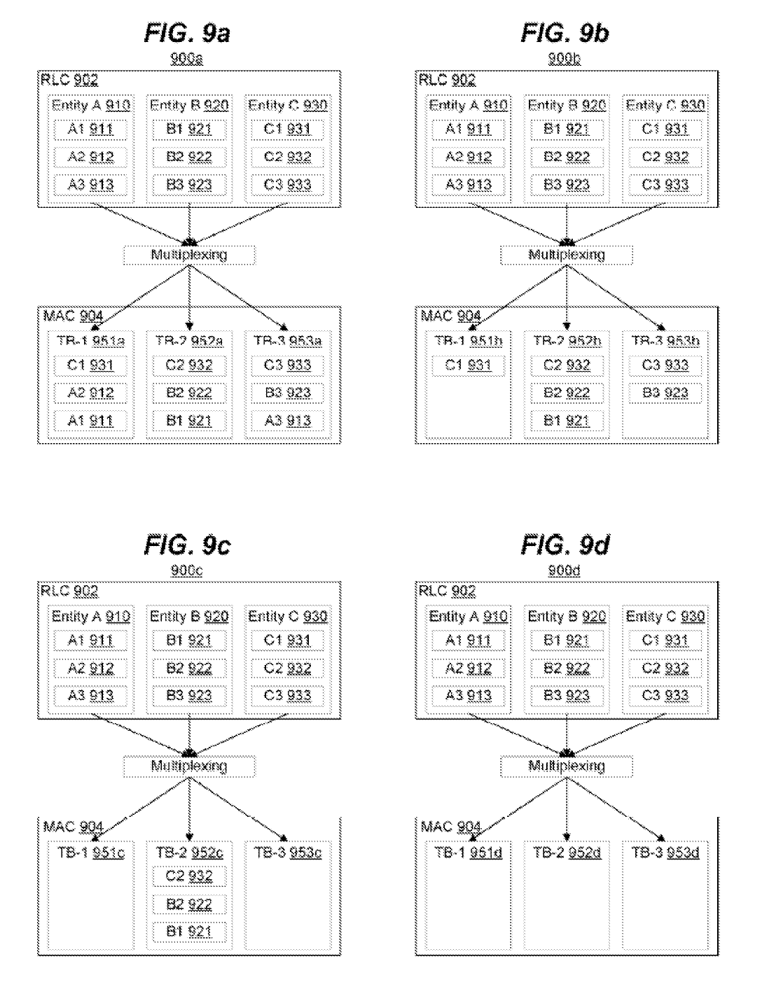

In one embodiment, each wireless node 200 may include only one instantiation of the MAC sub-layer 308. In various embodiments, this MAC sub-layer 308 may be associated with multiple RLC peer entities. In such an embodiment, when transmitting data, the MAC 308 may multiplex the RLC PDUs from several RLC entities into one or more Transport Blocks (TBs). This is discussed in more detail in reference to FIG. 9.

In various embodiments using the E-UTRAN standard, time may be divided into increments known as Transmission Time Intervals (TTIs). During each TTI the MAC 308 may transmit or receive one or more TBs. For example, during each TTI the UE 106 and the BS 104 of FIG. 1 may exchange one or more TBs via the radio bearers 112a, 112b, and 112c. In various embodiments, an error control mechanism used for data transfer known as Hybrid Automatic Repeat Request (HARQ) are used at the MAC level and Automatic Repeat Request (ARQ) used at RLC level for error correction.

In a simplified form, HARQ may include, in one embodiment, an error control method for data transmission which uses acknowledgments and timeouts to achieve reliable data transmission. For example, data may be transmitted from one peer entity to another peer entity. Upon receipt of the data the receiving peer entity may check to confirm that the data was received correctly and was not corrupted during transmission. If the data was correctly received, an acknowledgment message may be transmitted to the sending peer entity. If the data was not received correctly, a request for re-transmittal may be sent to the sending peer entity. The sending peer entity may then re-send the data when a new TTI becomes available. Such re-transmissions may occur until, in various embodiments, the data is correctly received, a certain number of re-transmissions have occurred, or another event occurs. In various embodiments, HARQ operates at the transport block (TB) level to ensure that TBs are transferred without transmission or data corruption errors. In embodiments, in which several RLC peer entities are associated with the MAC sub-layer 308, there may often be several parallel HARQ processes in the MAC 308. A more complex description of one embodiment of the data transfer and the HARQ process may be found in the E-UTRAN standard.

In some embodiments, an error or other situation may occur in which the connection between the RLC peer entity pairs need to be or it would be desirable to be re-established. In some embodiments, a RLC re-establishment may occur due to the following example scenarios: (1) a maximum number of RLC PDU retransmissions is reached; (2) the reception of erroneous RLC PDU sequence number in a given transmission/reception window; (3) the reception of erroneous header information; or (4) it is detected that one or multiple RLC entities are in unrecoverable error state; although, it is understood that the above are merely a few illustrative examples to which the disclosed subject matter is not limited. These instances may occur, for example, due to erroneous software or hardware implementations.

In various embodiments, a RLC Re-establishment may be executed when requested by the RRC 302. In various embodiments, the RLC re-establishment may include the re-initialization of RLC sub-layer 306 buffers, variables and timers, etc.

In some embodiments, the RLC Re-establishment procedure may include the resetting of an individual RLC entity or all the RLC entities of the wireless device 200. Generally, RLC re-establishment is used to reset both RLC entities in a RLC peer entity pair. A more complete description of one embodiment of the re-establishment of the RLC sub-layer 306 and the memory structures that are reset may be found in the E-UTRAN standard.

In the known E-UTRAN standard, the RLC re-establishment of a peer entity may occur without the resetting or re-initialization of other sub-layers in the network layer model (e.g., the MAC 308). Due to this, data corruption and errors may occur, in one embodiment. An example of a possible error is described below.

In various embodiments, because of the operation of the HARQ protocol, RLC PDUs can be received by the RLC receiving entity in a different order than the PDUs are sent from the corresponding peer entity. For example, if a first PDU is transmitted, becomes corrupted during transmission, and a re-transmission is requested, a second PDU may arrive in an uncorrupt state at the receiving peer entity before the first PDU is properly re-transmitted.

When, in one embodiment, a RLC re-establishment is executed purely on RLC level there may be RLC PDUs belonging to the old RLC state (before the RLC re-establishment) under transmission at the MAC level, even though the RLC state has changed to a new RLC state due to the RLC Re-establishment.

Returning to the above example, if in between the receipt of the second PDU and the re-transmission of the first PDU, a RLC re-establishment occurs between the two RLC peer entities, the variables, timers, and counters (including the PDU sequence numbers) will be reset. Unfortunately, if the old first PDU has already been placed in a MAC sub-layer transport block (TB) before the RLC re-establishment, the old first PDU will still be transmitted. When the old first PDU arrives at the receiving peer entity it may not correspond with the post-re-established RLC peer entity's variables and state tables. Or, worse, it may appear to correspond (e.g., it may have a valid sequence number) with the post-re-established RLC peer entity's variables and state tables but not be valid or expected data. For example, if the old first PDU arrives and a new (post-re-establishment) first PDU is expected, a case of mistaken identity may occur and the old first PDU may be incorrectly treated as if it was the expected new first PDU. Such a case of mistaken identity may cause data corruption of the larger data stream that includes the new first PDU.

In various embodiments, a conflict situation may now occur as the Receiving RLC entity has received data from the reset Transmitting RLC entity but Receiving RLC entity considers this to be new valid data. Generally, it can not be detected via RLC PDU header contents whether the received data belongs to a RLC protocol state before or after the RLC Re-establishment. Because the RLC re-establishment typically clears all RLC entity buffers, variables and timers, it is fatal for the functioning of the data protocol if data from a pre-re-establishment state is received by a re-established RLC sub-layer.

The current E-UTRAN standard does not provide a means to remove RLC PDUs from MAC sub-layer. RLC PDUs from a given RLC entity, which are under transmission by the MAC sub-layer 308, cannot be removed from a given HARQ processes because the same HARQ process may also contain RLC PDUs (and control messages) from other RLC entities. Additionally, the data in the HARQ processes cannot be modified because of the HARQ operation (combining of received data, allocation size, etc.).

Various techniques are described below that attempt to correct or ameliorate errors (such as that described above) from occurring. It is understood that the above are merely a few illustrative examples to which the disclosed subject matter is not limited. It is also understood that the below are merely a few example embodiments to which the disclosed subject matter is not limited.

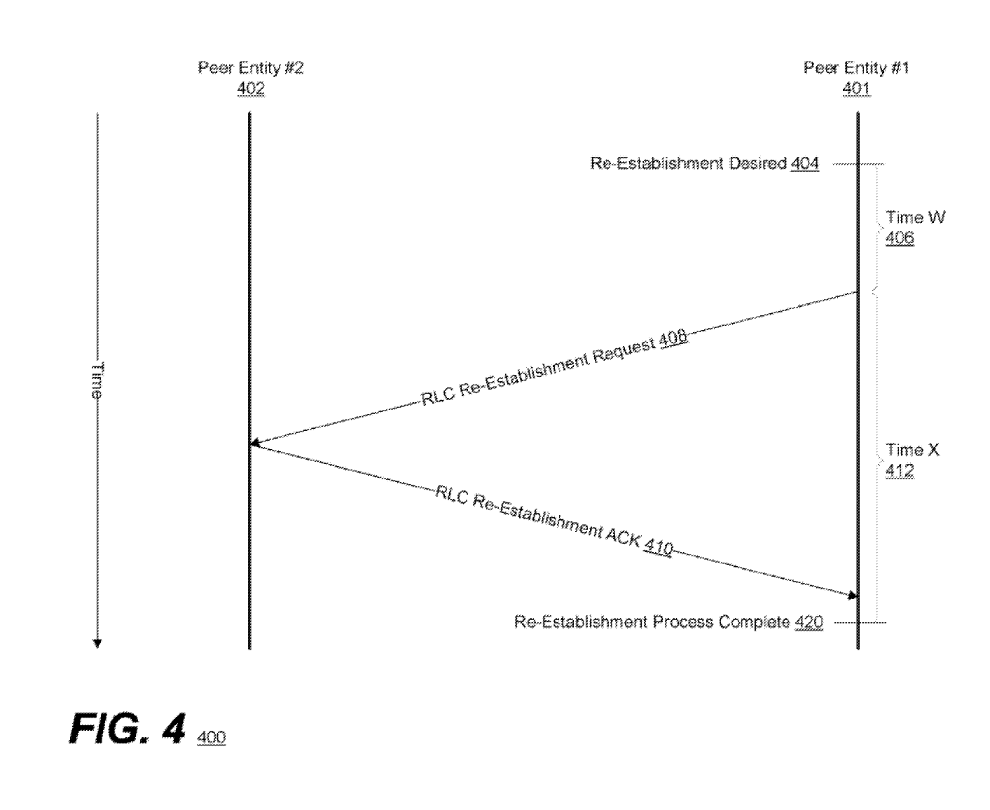

FIG. 4 is a timing diagram of a wireless network 400 in accordance with an example embodiment of the disclosed subject matter. In one embodiment, the wireless network 400 may include a first peer entity 401 and a second peer entity 402. In various embodiments, one of the peer entities may be included as part of a user equipment (UE) or mobile station. In another embodiment, the other the peer entity may be included as part of base station (BS) or eNB. It is understood that the actions described are essentially bi-directional.

In one embodiment, at time 404 the first peer entity 401 may detect or determine that a RLC re-establishment is desired. In various embodiments, an error may have occurred, such as those described above, in which a RLC re-establishment may be desirable. In one embodiment, once the desire for a RLC re-establishment has been determined the RLC entity may stop providing PDUs to the MAC sub-layer for transmission.

Typically, the RLC Re-establishment procedure includes transmitting a RLC Re-establishment Request 408 to the other peer entity 402 once the desire for re-establishment has been determined. However, as described above, various PDUs from before the RLC re-establishment may be in transit between the peer entities or within one of the MAC sub-layers of the peer entities; although, it is understood that the above are merely a few illustrative examples to which the disclosed subject matter is not limited.

Therefore, the first peer entity 401 may wait or delay transmitting a RLC Re-establishment Request 408 until a first period of time W 406 has passed. In one embodiment, the time period W 406 may be selected to be sufficient to allow any RLC peer entity PDUs in the MAC sub-layer to be transmitted to the second peer entity 402. In one embodiment, the time period W 406 may be a configurable variable of the peer entity or device. In another embodiment, the time period W 406 may be a standardized period of time. In yet another embodiment, the time period W 406 may be variable and based upon the state of data transmission, such as HARQ retransmit times. It is understood that the above are merely a few illustrative examples to which the disclosed subject matter is not limited.

In one embodiment, the second peer entity 402 may receive the RLC Re-Establishment Request 408. In one embodiment, in response to the RLC Re-Establishment request 408, the second peer entity 402 may reset the peer entity's RLC sub-layer. In one embodiment, once the RLC re-establishment request 408 has been received the second RLC entity 402 may stop providing PDUs to the MAC sub-layer for transmission. In response to the Request 408, in one embodiment, the second peer entity 402 may transmit a RLC Re-Establishment acknowledgement (ACK) 410 message to the first peer entity 401. In another embodiment, an ACK message 410 may not be transmitted but instead the successful re-establishment of the second peer entity's RLC sub-layer may be assumed by the first peer entity 401.

In one embodiment, the first peer entity 401 may wait a second time period X 412 after transmitting the RLC Re-establishment Request 406 in order to complete the RLC Re-establishment process. This second time period X 412 may allow for the RLC Re-establishment of the second peer entity 402 and the transmittal of any pre-re-establishment data from the second peer entity 402 to the first peer entity 401. In various embodiments, during this time period, data may be received from the second peer entity 402, but data may not be transmitted by the first peer entity 401. In another embodiment, data may be both transmitted and received. It is also understood that because peer entities within a single device are relatively autonomous, other peer entities (not shown) that share the same device as the first peer entity may not, in one embodiment, be prevented from sending or transmitting data. In one embodiment, after the second period of time X 412 is complete the RLC Re-establishment Process may be complete 420 and normal operation between the two peer entities 401 and 402 may resume.

In one embodiment, the time period X 412 may be a configurable variable of the peer entity or device. In another embodiment, the time period X 412 may be a standardized period of time. In yet another embodiment, the time period X 412 may be variable and based upon the state of data transmission, such as HARQ retransmit times. In one embodiment, the time period X 412 and the time period W 406 may be the same length. It is understood that the above are merely a few illustrative examples to which the disclosed subject matter is not limited.

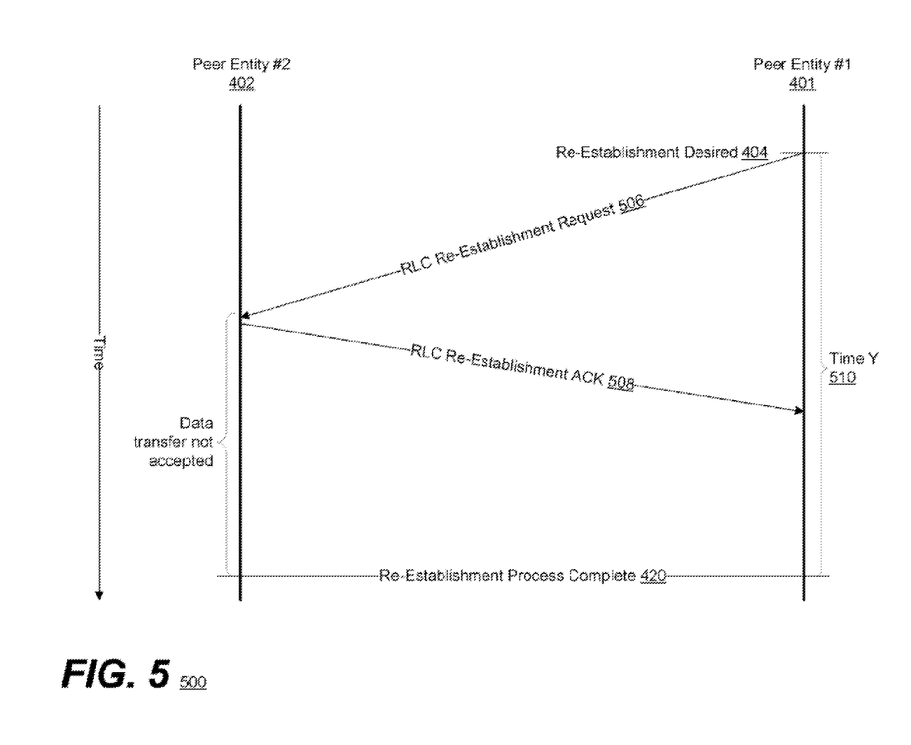

FIG. 5 is a timing diagram of a wireless network 500 in accordance with an example embodiment of the disclosed subject matter. In one embodiment, the wireless network 500 may include a first peer entity 401 and a second peer entity 402. In various embodiments, one of the peer entities may be included as part of a user equipment (UE) or mobile station. In another embodiment, the other of the peer entities may be included as part of base station (BS) or eNB. It is understood that the actions described are essentially bi-directional.

In one embodiment, at time 404 the first peer entity 401 may detect or determine that a RLC re-establishment is desired. In various embodiments, an error may have occurred, such as those described above, in which a RLC re-establishment may be desirable. In one embodiment, once the desire for a RLC re-establishment has been determined the RLC entity 401 may stop providing PDUs to its associated MAC sub-layer for transmission. In one embodiment, the RLC Re-establishment procedure may include transmitting a RLC Re-establishment Request 506 to the other peer entity 402 once the desire for re-establishment has been determined.

In one embodiment, the RLC Re-establishment Request 408 may include a parameter describing a period of time that the re-establishment process will take. In another embodiment, this period time Y 510 may be a standardized value and not transmitted with the RLC Re-establishment Request 506.

In one embodiment, the period of time Y 510 may be a period of time counted from the time the RLC Re-establishment Request 506 was transmitted from the first peer entity 401. During the period of time Y 510, in one embodiment, the first and second peer entities 401 and 402 may refuse to accept data transfers. In another embodiment, during the period of time Y 510 the first and second peer entities 401 and 402 may only accept data transfers that directly relate to the RLC Re-establishment process, for example, the RLC Re-establishment Request 506 or the RLC Re-establishment Request ACK 508.

In various embodiments, not accepting data may include receiving and discarding the data and not transmitting a corresponding ACK message. It is understood that the above is merely one illustrative example to which the disclosed subject matter is not limited. In one embodiment, the period of time Y 510 may be sufficiently long to ensure that any data or PDUs associated with the peer entities and in the MAC sub-layers of the devices are transmitted but not accepted by the peer entities.

In one embodiment, in response to the RLC Re-establishment Request 506 the second peer entity 402 may reset or re-establish its RLC sub-layer or the RLC peer entity 402 portion thereof. In various embodiments, the second peer entity 402 may transmit a RLC Re-establishment Request ACK 508 to the first peer entity 401.

In one embodiment, once the time period Y 510 has expired the peer entities 401 and 402 may consider the RLC Re-establishment process complete 420. In various embodiments, the receipt of the RLC Re-establishment Request ACK 508 message by the first peer entity 401 may not be determinative as to whether or not the RLC Re-establishment process is complete. Upon completion of the RLC Re-establishment process the normal operation between the two peer entities 401 and 402 may resume.

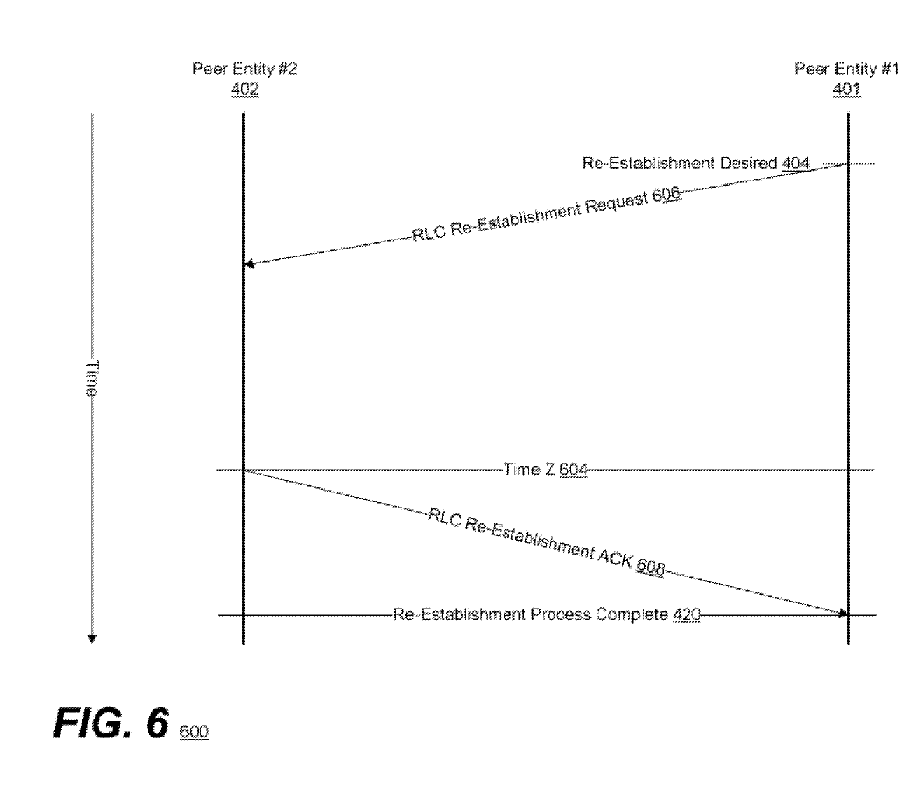

FIG. 6 is a timing diagram of a wireless network 600 in accordance with an example embodiment of the disclosed subject matter. In one embodiment, the wireless network 600 may include a first peer entity 401 and a second peer entity 402. In various embodiments, one of the peer entities may be included as part of a user equipment (UE) or mobile station. In another embodiment, the other of the peer entities may be included as part of base station (BS) or eNB. It is understood that the actions described are essentially bi-directional.

In one embodiment, at time 404 the first peer entity 401 may detect or determine that a RLC re-establishment is desired. In various embodiments, an error may have occurred, such as those described above, in which a RLC re-establishment may be desirable. In one embodiment, once the desire for a RLC re-establishment has been determined the RLC entity 401 may stop providing PDUs to its associated MAC sub-layer for transmission. In one embodiment, the RLC Re-establishment procedure may include transmitting a RLC Re-establishment Request 606 to the other peer entity 402 once the desire for re-establishment has been determined.

In one embodiment, the RLC Re-establishment Request 606 may include a parameter specifying the time at which the RLC Re-establishment process will complete, or, in another embodiment, when the second peer entity 402 may transmit the RLC Re-establishment Request ACK message 608. In various embodiments, as opposed to the time periods of FIGS. 4 and 5 which may include counters, the time Z 604 may be an absolute time (e.g., “at 12:00 noon”; although it is expected that in many embodiments a time measured in milliseconds may be used). In another embodiment, the parameter included in the RLC Re-establishment Request 606 may be a variable or relative time (e.g., “in 5 minutes”) from which the Time Z 604 may be derived.

In one embodiment, the time Z 604 may be a configurable variable of the peer entity or device. In another embodiment, the time Z 604 may be a standardized time or time increment. In yet another embodiment, the time Z 604 may be variable and based upon the state of data transmission, such as HARQ retransmit times. It is understood that the above are merely a few illustrative examples to which the disclosed subject matter is not limited.

In one embodiment, the peer entities 401 and 402 may delay the completion of the RLC Re-establishment process until the Time Z 604 has been reached. In one embodiment, during this waiting period the peer entities may discard any data received that is not directly related to the RLC Re-establishment process (e.g., the RLC Re-establishment request 606 or the RLC Re-establishment request ACK 608, etc.), as described above. In another embodiment, the peer entities may receive and transmit data normally.

In one embodiment, once the Time Z 604 has been reached the two peer entities 401 and 402 may consider the RLC Re-establishment process to be complete. In another embodiment, once the Time Z 604 has been reached the second peer entity 402 may transmit a RLC Re-establishment request ACK 608 to the first peer entity 401. In such an embodiment, the second peer entity 402 may consider the RLC Re-establishment process to be complete and proceed to process data normally. Conversely, in such an embodiment, the first peer entity 401 may not consider the RLC Re-establishment process to be complete until the RLC Re-establishment request ACK 608 is received.

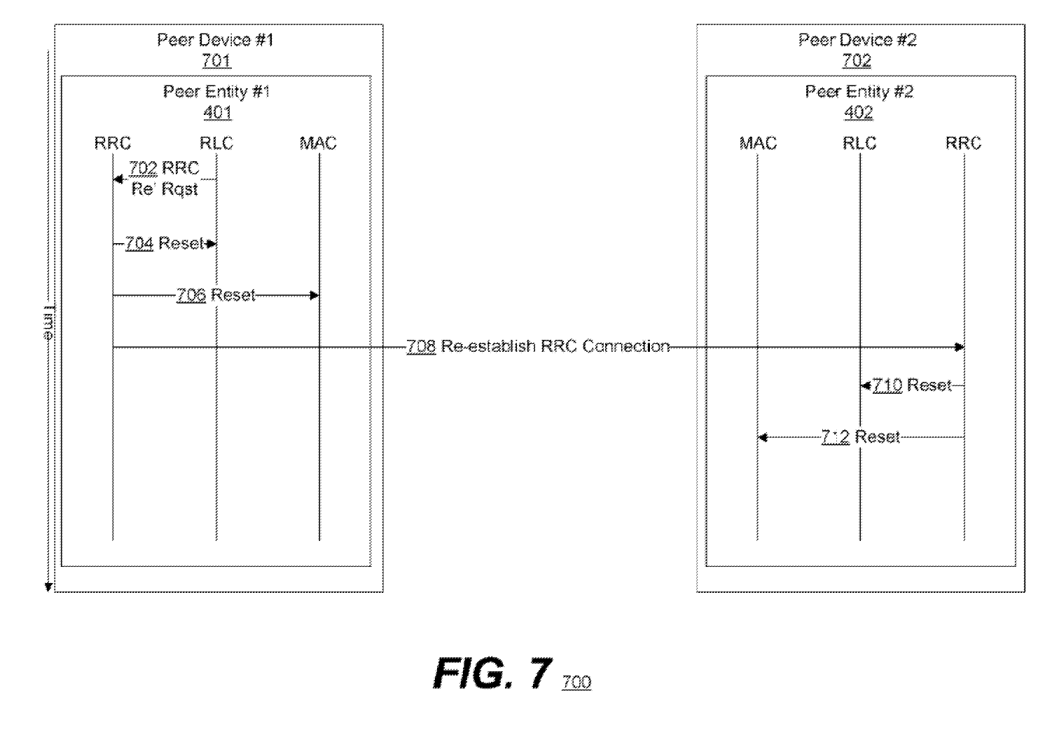

Unlike the embodiments described above in reference to FIGS. 4, 5, and 6 which as one feature of the embodiments attempt to delay the completion of the RLC Re-establishment process until any old data may be transmitted, the embodiments described below in reference to FIGS. 7, 8, and 9 illustrates may include embodiments that attempt to prevent any old data from being transmitted until the RLC re-establishment process is complete. It is understood that the above are merely a few illustrative examples of features of the embodiments to which the disclosed subject matter is not limited. It is also understood that the embodiments are not mutually exclusive and may be mixed or matched.

FIG. 7 is a timing diagram of a wireless network 700 in accordance with an example embodiment of the disclosed subject matter. In one embodiment, the wireless network 700 may include a first peer device 701, that includes a first peer entity 401, and a second peer device 702, that includes a second peer entity 402. In various embodiments, one of the peer entities may be included as part of a user equipment (UE) or mobile station. In another embodiment, the other of the peer entities may be included as part of base station (BS) or eNB. It is understood that the actions described are essentially bi-directional.

In one embodiment, once the first peer entity 401 has determined that a RLC Re-establishment with the second peer entity 402 is desirable, the first peer entity 401 may request, not a RLC Re-establishment, but a RRC Re-establishment 702 of the RRC sub-layer associated with the first peer entity 401. In various embodiments, such a re-establishment or reset of the network layer may include a reset of the data layer that includes the first peer entity 401. In some embodiments, a reset or re-establishment of a networking layer hierarchically above the data layer (e.g., the RRC sub-layer, or the Application layer, etc.) may be requested.

In such an embodiment, in response to the RRC Re-establishment request 702, the peer device 701 may reset 704 the RLC sub-layer. In various embodiments, resetting the RLC sub-layer may include resetting or re-establishing the RLC peer entity 401. In some embodiments, the resetting the RLC sub-layer may also include resetting or re-establishing any other RLC peer entities includes in the peer device 701.

In one embodiment, in response to the RRC Re-establishment request 702, the peer device 701 may reset 706 the MAC sub-layer. In various embodiments, resetting the MAC sub-layer may include discarding, deleting, or flushing the MAC sub-layer buffers, transport blocks (TBs), PDUs, HARQ processes, etc. In one embodiment, this may prevent the MAC sub-layer from transmitting any data that existed prior to the RLC sub-layer re-establishment.

In one embodiment, in response to the RRC Re-establishment request 702, the peer device 701 may transmit a RRC re-establishment request 708 to the second peer device 702. In various embodiments, as with the first peer device 701, the RRC re-establishment request 708 may cause the second peer device 702 to reset its RLC sub-layer 710 and MAC sub-layer 712. In various embodiments, once the data layers of the first and second peer devices 701 and 702 have been re-established, normal data communication may resume.

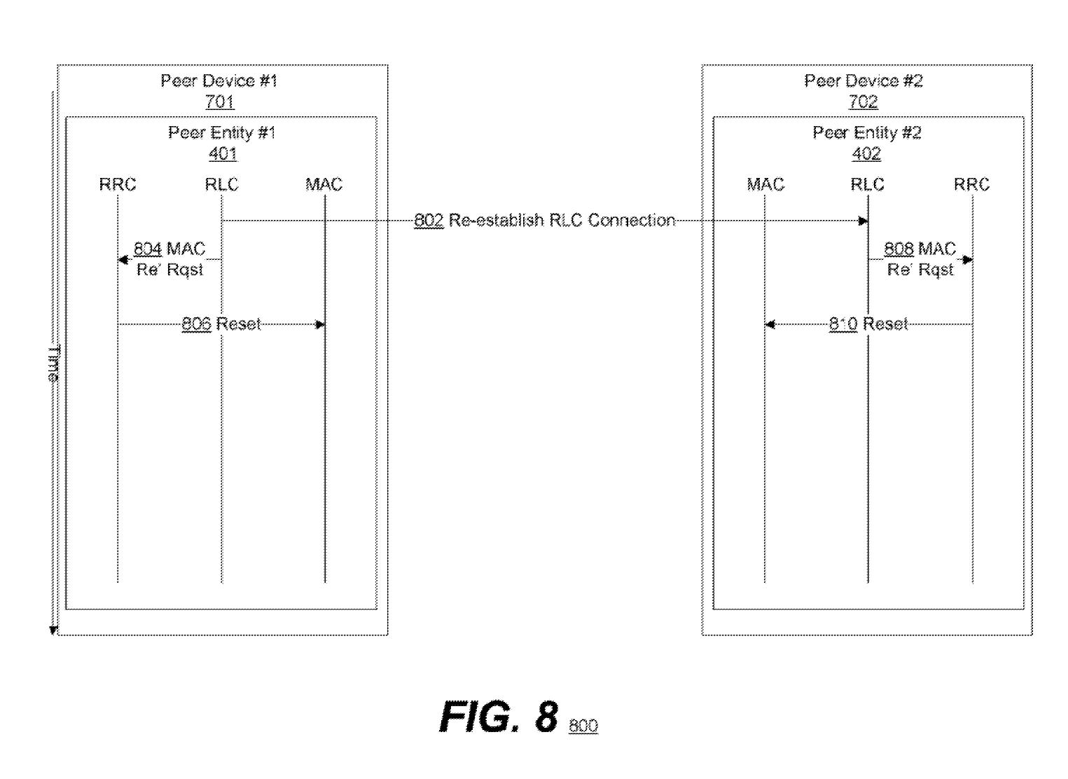

FIG. 8 is a timing diagram of a wireless network 800 in accordance with an example embodiment of the disclosed subject matter. In one embodiment, the wireless network 800 may include a first peer device 701, that includes a first peer entity 401, and a second peer device 702, that includes a second peer entity 402. In various embodiments, one of the peer entities may be included as part of a user equipment (UE) or mobile station. In another embodiment, the other of the peer entities may be included as part of base station (BS) or eNB. It is understood that the actions described are essentially bi-directional.

In one embodiment, once the first peer entity 401 has determined that a RLC Re-establishment with the second peer entity 402 is desirable, the first peer entity 401 may request a RLC re-establishment 802 with the second peer entity 402. In addition, the peer entity 401 may request that the MAC sub-layer, or a portion thereof, be reset 804. In one embodiment, the request may be made to the RRC sub-layer or another responsible control entity included within the first peer device 701.

In one embodiment, in response to the MAC sub-layer reset request 804 the MAC sub-layer may be reset 806. In one embodiment, the MAC sub-layer may be reset as described above. In another embodiment, only a portion of the MAC sub-layer may be reset, flushed, or deleted. One such embodiment may include the process described below in reference to FIG. 9. It is understood that the above are merely a few illustrative examples to which the disclosed subject matter is not limited.

In one embodiment, in response to the request for RLC re-establishment 802 the second peer entity 402 may request that its associated MAC sub-layer be reset 808. In one embodiment, in response to the MAC sub-layer reset request 808 the MAC sub-layer may be reset 810. In one embodiment, the MAC sub-layer may be reset as described above. In another embodiment, only a portion of the MAC sub-layer may be reset, flushed, or deleted. One such embodiment may include the process described below in reference to FIG. 9. It is understood that the above are merely a few illustrative examples to which the disclosed subject matter is not limited.

In one embodiment, the RLC re-establishment process may include the resetting of the MAC sub-layers, or a portioned thereof, associated with the respective peer entities 401 and 402. In various embodiments, once the RLC re-establishment process is complete and the MAC sub-layers are reset, normal data communication between the two peer entities 401 and 402 may resume.

FIG. 9 is a block diagram of a wireless device 900 in accordance with an example embodiment of the disclosed subject matter. Four embodiments of wireless device 900 are illustrated (900a, 900b, 900c, and 900d). It is understood that like numerals differing only by suffix (a, b, c, or d) are analogous. In one embodiment, the wireless device 900 may include a RLC sub-layer 902 and a MAC sub-layer 904.

The RLC sub-layer 902 may include three RLC peer entities Entity A 910, Entity B 920, and Entity C 930. In various embodiments, these three RLC peer entities may have counterparts in one to three other wireless devices. Although for simplicity's sake, in this illustrative example all three entities correspond to three RLC entities in a single peer device. It is understood that the above are merely an illustrative example to which the disclosed subject matter is not limited.

In one embodiment, Entity A 910 may include three PDUs: A1 911, A2 912, and A3 913. Entity B 920 may include three PDUs: B1 921, B2 922, and B3 923. Entity C 930 may include three PDUs: C1 931, C2 932, and C3 933. The MAC sub-layer 904 may include three transport blocks (TBs): TB-1 951, TB-2 952, and TB-3 953. In various embodiments, each TB may represent an individual HARQ process (e.g., HARQ-1, HARQ-2, and HARQ-3). It is understood that the above are merely a few illustrative examples to which the disclosed subject matter is not limited.

FIG. 9a illustrates a normalized state of the MAC sub-layer 904 before any RLC re-establishment requests have been made or determined to be desired. As described above, as PDUs are moved from the RLC sub-layer 902 to the MAC sub-layer 904 they are, in one embodiment, multiplexed or scheduled by the MAC sub-layer 904. In the illustrated embodiment, PDUs C1 931, A2 912, and A1 911 may be assigned to TB-1 951a. PDUs C2 932, B2 922, and B1 921 may be assigned to TB-2 952a. PDUs C3 933, B3 923, and A3 913 may be assigned to TB-3 953a. These TBs may be transmitted to the corresponding peer device. If, for example, TB-1 951 (which is HARQ-1) becomes corrupt during transmission the HARQ process would request that TB-1 951 be re-transmitted. Therefore, PDUs C1 931, A2 912, and A1 911 would all normally, in one embodiment, be re-transmitted. However, as described above, if between the original transmittal of TB-1 951 and the re-transmittal of TB-1 951, RLC Entity A 910 where to be reset or re-established an error may occur.

FIG. 9b illustrates a first embodiment of a wireless device 900b in accordance with an example embodiment of the disclosed subject matter. In one embodiment, the controller, processor or other portion of the wireless device 900b may be configured to selectively delete, flush, or remove PDUs associated with a re-established RLC entity (e.g., Entity A 910) from the MAC sub-layer 904.

In one embodiment, the PDUs A2 912 and A1 911 may be flushed from the TB-1 951b. And, the PDU A3 913 may be flushed from the TB-3 953b. In such an embodiment, the TBs 951b and 953b may be transmitted without incurring the errors described above. In one embodiment, the selective deletion and flushing may occur in response to a specific request (e.g., the MAC reset request 804 of FIG. 8). In another embodiment, the selective deletion and flushing may occur due to the peer device 900 monitoring the status of the RLC entities 910, 920, and 930. It is understood that the above are merely a few illustrative examples to which the disclosed subject matter is not limited.

FIG. 9c illustrates a second embodiment of a wireless device 900c in accordance with an example embodiment of the disclosed subject matter. In one embodiment, the controller, processor or other portion of the wireless device 900c may be configured to selectively delete, flush, or remove TBs associated with a re-established RLC entity (e.g., Entity A 910) from the MAC sub-layer 904.

In one embodiment, the TBs 951c and 953c may be flushed from the MAC sub-layer 904. In such an embodiment, only TB 952c may be transmitted without incurring the errors described above. In one embodiment, the selective deletion and flushing may occur in response to a specific request (e.g., the MAC reset request 804 of FIG. 8). In another embodiment, the selective deletion and flushing may occur due to the peer device 900 monitoring the status of the RLC entities 910, 920, and 930. It is understood that the above are merely a few illustrative examples to which the disclosed subject matter is not limited.

FIG. 9d illustrates a third embodiment of a wireless device 900d in accordance with an example embodiment of the disclosed subject matter. In one embodiment, the controller, processor or other portion of the wireless device 900d may be configured to delete, flush, or remove all TBs from the MAC sub-layer 904 if any PDUs associated with a re-established RLC entity (e.g., Entity A 910) are present. Alternately, in another embodiment, the wireless device 900d may be configured to delete, flush, or remove all data from the MAC sub-layer 904 if any RLC entities associated with the MAC sub-layer 904 are re-established (e.g., Entity A 910).

In one embodiment, the TBs 951d, 952d and 953d may all be flushed from the MAC sub-layer 904. In such an embodiment, no TBs may be transmitted and therefore none of the errors described above may occur. In one embodiment, the deletion and flushing may occur in response to a specific request (e.g., the MAC reset request 804 of FIG. 8). In another embodiment, the selective deletion and flushing may occur due to the peer device 900 monitoring the status of the RLC entities 910, 920, and 930. It is understood that the above are merely a few illustrative examples to which the disclosed subject matter is not limited.

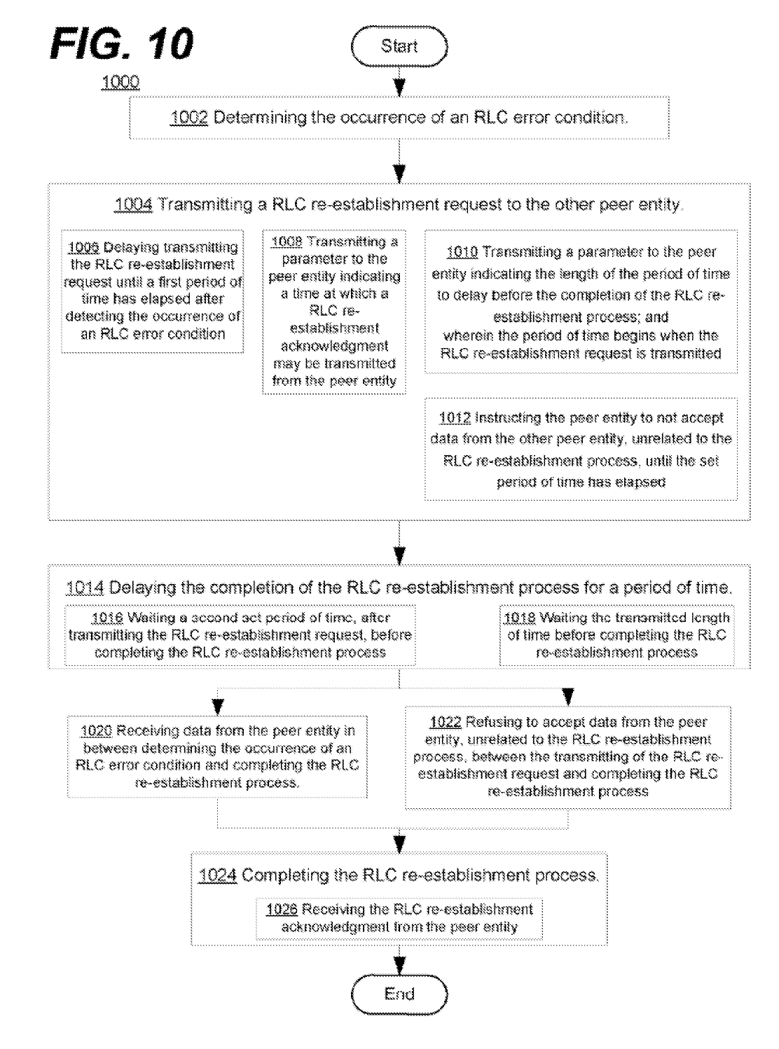

FIG. 10 is a flowchart of a technique 1000 in accordance with an example embodiment of the disclosed subject matter. In various embodiments, parts or all of the technique 1000 may be used to produce a system or apparatus confirming to the timing diagrams of FIGS. 4, 5 and/or 6. Although, it is understood that other systems and timing diagrams my result from the use of technique 1000.

Block 1002 illustrates that, in one embodiment, the occurrence of an RLC error condition may be detected or determined. In another embodiment, the desirability of a RLC re-establishment may be determined that does not include an RLC error. In one embodiment, the controller 204 of FIG. 2 or the first peer entity 401 of FIG. 4 may determine the desire for a RLC re-establishment, as described above.

Block 1004 illustrates that, in one embodiment, a RLC re-establishment request may be transmitted to another peer entity. In one embodiment, the transceiver 202 of FIG. 2 or the first peer entity 401 of FIG. 4 may transmit the RLC re-establishment request, as described above.

Block 1006 illustrates that, in one embodiment, transmitting may include delaying transmitting the RLC re-establishment request until a first period of time (e.g., Time W 406 of FIG. 4) has elapsed after detecting the occurrence of an RLC error condition. In one embodiment, the controller 204 of FIG. 2 or the first peer entity 401 of FIG. 4 may delay the request, as described above.

Block 1008 illustrates that, in one embodiment, transmitting may include transmitting a parameter to the peer entity indicating a time at which a RLC re-establishment acknowledgment may be transmitted from the peer entity. In one embodiment, the transceiver 202 of FIG. 2 or the first peer entity 401 of FIG. 6 may transmit the RLC re-establishment request, as described above. In one embodiment, the parameter may include the Time Z 604 of FIG. 6, as described above.

Block 1010 illustrates that, in one embodiment, transmitting may include transmitting a parameter to the peer entity indicating the length of the period of time to delay before the completion of the RLC re-establishment process. In various embodiments, the period of time may begin when the RLC re-establishment request is transmitted. In one embodiment, the transceiver 202 of FIG. 2 or the first peer entity 401 of FIG. 5 may transmit the RLC re-establishment request, as described above. In one embodiment, the parameter may include the Time Y 510 of FIG. 5, as described above.

Block 1012 illustrates that, in one embodiment, transmitting may include instructing the peer entity to not accept data from the other peer entity, unrelated to the RLC re-establishment process, until the set period of time has elapsed. In one embodiment, the transceiver 202 of FIG. 2 or the first peer entity 401 of FIG. 5 may transmit the instruction, as described above.

Block 1014 illustrates that, in one embodiment, the completion of the RLC re-establishment process may be delayed for a period of time. In one embodiment, the controller 204 of FIG. 2 or the first peer entity 401 of FIG. 4 may delay the completion of the process, as described above.

Block 1016 illustrates that, in one embodiment, delaying may include waiting a second set period of time (e.g., Time X 412 of FIG. 4), after transmitting the RLC re-establishment request, before completing the RLC re-establishment process. In one embodiment, the controller 204 of FIG. 2 or the first peer entity 401 of FIG. 4 may delay the completion, as described above.

Block 1018 illustrates that, in one embodiment, delaying may include waiting the transmitted length (e.g., of Block 1008) of time before completing the RLC re-establishment process. In one embodiment, the controller 204 of FIG. 2 or the first peer entity 401 of FIG. 4 may delay the completion, as described above.

Block 1020 illustrates that, in one embodiment, data from the peer entity may be received in between determining the occurrence of an RLC error condition and completing the RLC re-establishment process. In one embodiment, the controller 204 of FIG. 2, the first peer entity 401 of FIG. 4, or the first peer entity 401 of FIG. 6 may receive the data, as described above.

Block 1022 illustrates that, in one embodiment, data from the peer entity may be refused or not accepted in between determining the occurrence of an RLC error condition and completing the RLC re-establishment process. In one embodiment, the controller 204 of FIG. 2, the first peer entity 401 of FIG. 5, or the first peer entity 401 of FIG. 6 may reject the data, as described above.

Block 1024 illustrates that, in one embodiment, the RLC re-establishment process may be completed once the period of time has expired. In one embodiment, the controller 204 of FIG. 2 or the first peer entity 401 of FIG. 6 may complete the RLC re-establishment process, as described above.

Block 1026 illustrates that, in one embodiment, completing may include receiving a RLC re-establishment acknowledgement from the peer entity. In some embodiments, the receipt of the acknowledgment may only be determinative after the period of time has expired. In one embodiment, the controller 204 of FIG. 2 or the first peer entity 401 of FIG. 6 may complete the RLC re-establishment process, as described above.

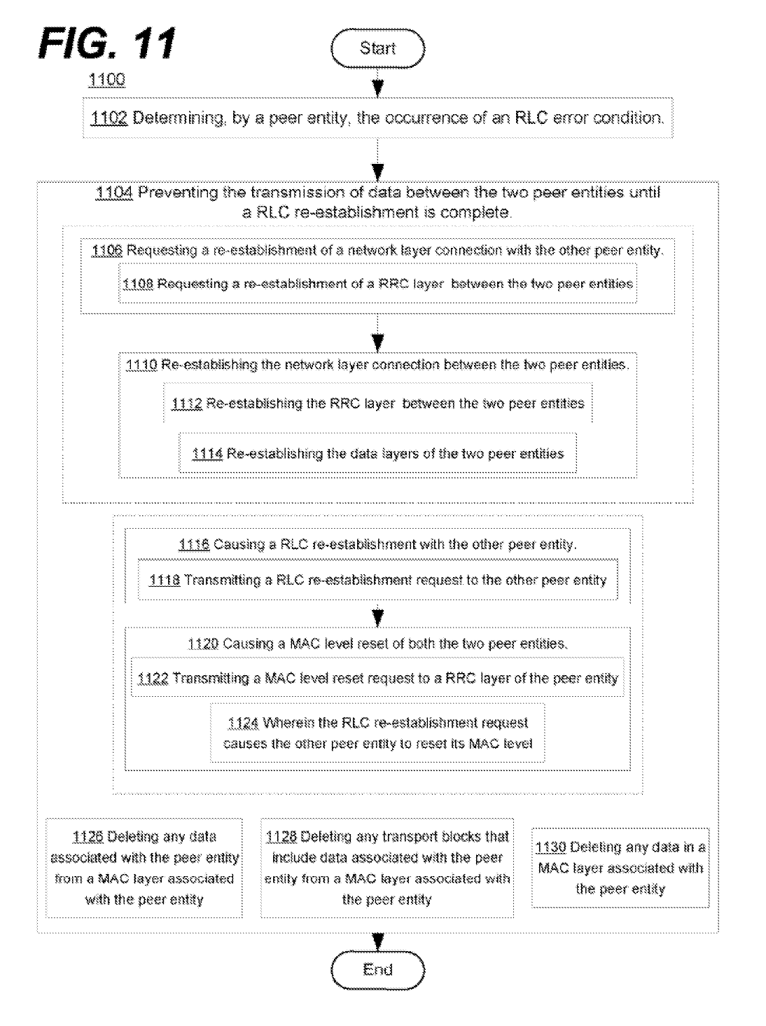

FIG. 11 is a flowchart of a technique 1100 in accordance with an example embodiment of the disclosed subject matter. In various embodiments, parts or all of the technique 1100 may be used to produce a system or apparatus confirming to the timing diagrams of FIGS. 7, 8, and/or 9. Although, it is understood that other systems and timing diagrams my result from the use of technique 1100.

Block 1102 illustrates that, in one embodiment, the occurrence of an RLC error condition may be detected or determined by a peer entity. In another embodiment, the desirability of a RLC re-establishment may be determined in such a way that does not include an RLC error. In one embodiment, the controller 204 of FIG. 2 or the first peer entity 401 of FIG. 7 may determine the desire for a RLC re-establishment, as described above.

Block 1104 illustrates that, in one embodiment, the peer entity may prevent the transmission of data between the two peer entities until a RLC re-establishment is complete. In one embodiment, the controller 204 of FIG. 2 or the first peer entity 401 of FIG. 7 may prevent the transmission of data, as described above.

Block 1106 illustrates that, in one embodiment, preventing may include requesting a re-establishment of a network layer connection with the other peer entity. Block 1108 illustrates that, in one embodiment, requesting a re-establishment of a network layer connection with the other peer entity may include requesting a re-establishment of a RRC layer between the two peer entities. In one embodiment, the transceiver 202 of FIG. 2 or the first peer entity 401 of FIG. 7 may transmit the requests, as described above.

Block 1110 illustrates that, in one embodiment, preventing may include re-establishing the network layer connection between the two peer entities. Block 1112 illustrates that, in one embodiment, re-establishing the network layer may include re-establishing the RRC layer between the two peer entities. Block 1114 illustrates that, in various embodiments, re-establishing the network layer may include Re-establishing the data layer(s) of the two peer entities. In one embodiment, the controller 204 of FIG. 2 or the first peer entity 401 of FIG. 7 may re-establish the networking layers, as described above.

Block 1116 illustrates that, in one embodiment, preventing may include causing a RLC re-establishment with the other peer entity. Block 1118 illustrates that, in one embodiment, causing may include transmitting a RLC re-establishment request to the other peer entity. In one embodiment, the transceiver 202 of FIG. 2 or the first peer entity 401 of FIG. 8 may transmit the requests, as described above.

Block 1120 illustrates that, in one embodiment, preventing may include causing a MAC level reset of both the two peer entities. Block 1122 illustrates that, in one embodiment, causing may include transmitting a MAC level reset request to a RRC layer of the peer entity. Block 1124 illustrates that, in one embodiment, causing may include an embodiment wherein the RLC re-establishment request of Block 1118 causes the other peer entity to reset its MAC level. In one embodiment, the transceiver 202 of FIG. 2 or the first peer entity 401 of FIG. 8 may transmit the requests, as described above. In one embodiment, the controller 204 of FIG. 2 or the first peer entity 401 of FIG. 8 may cause the resets, as described above.

Block 1126 illustrates that, in one embodiment, preventing may include deleting any data associated with the peer entity from a MAC layer associated with the peer entity. Block 1128 illustrates that, in one embodiment, preventing may include deleting any transport blocks that include data associated with the peer entity from a MAC layer associated with the peer entity. Block 1130 illustrates that, in one embodiment, preventing may include deleting any data in a MAC layer associated with the peer entity. In one embodiment, the controller 204 of FIG. 2 or the MAC sub-layer 904 of FIG. 9 respective peer entities may delete of flush the data, as described above.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A method of re-establishing a radio link control (RLC) connection between a peer entity and another peer entity in a wireless network, the method comprising:
determining the occurrence of an RLC error condition;
transmitting a RLC re-establishment request to the other peer entity;
delaying the completion of the RLC re-establishment process for a period of time; and
completing the RLC re-establishment process.

2. The method of claim 1 wherein transmitting the RLC re-establishment request includes delaying transmitting the RLC re-establishment request until a first period of time has elapsed after determining the occurrence of an RLC error condition.

3. The method of claim 2 wherein delaying completion of the RLC re-establishment for a period of time includes:
waiting a second set period of time, after transmitting the RLC re-establishment request, before completing the RLC re-establishment process.

4. The method of claim 2 further including receiving data from the peer entity in between determining the occurrence of an RLC error condition and completing the RLC re-establishment process.

5. The method of claim 1 wherein transmitting a RLC re-establishment request includes:
transmitting a parameter to the peer entity indicating the length of the period of time to delay before the completion of the RLC re-establishment process; and
wherein the period of time begins when the RLC re-establishment request is transmitted.

6. The method of claim 5 further including refusing to accept data from the peer entity, unrelated to the RLC re-establishment process, between the transmitting of the RLC re-establishment request and completing the RLC re-establishment process.

7. The method of claim 5 wherein transmitting a RLC re-establishment request includes instructing the peer entity to not accept data from the other peer entity, unrelated to the RLC re-establishment process, until the set period of time has elapsed.

8. The method of claim 1 wherein transmitting a RLC re-establishment request includes:
transmitting a parameter to the peer entity indicating a time at which a RLC re-establishment acknowledgment may be transmitted from the peer entity; and
wherein completing the RLC re-establishment process includes receiving the RLC re-establishment acknowledgment from the peer entity.

9. A method of re-establishing a radio link control (RLC) connection between a peer entity and another peer entity comprising:
determining, by a peer entity, the occurrence of an RLC error condition; and
preventing the transmission of data between the two peer entities until a RLC re-establishment is complete.

10. The method of claim 9 wherein preventing the transmission of data includes:
requesting a re-establishment of a network layer connection with the other peer entity; and
re-establishing the network layer connection between the two peer entities.

11. The method of claim 10 wherein requesting a re-establishment of the network layer connection includes requesting a re-establishment of a RRC layer between the two peer entities; and
wherein re-establishing the network layer connection includes re-establishing the RRC layer between the two peer entities.

12. The method of claim 11 wherein re-establishing the network layer includes:
re-establishing the data layers of the two peer entities.

13. The method of claim 9 wherein preventing the transmission of data includes:
causing a RLC re-establishment with the other peer entity; and
causing a MAC level reset of both the two peer entities.

14. The method of claim 13 wherein causing a RLC re-establishment includes transmitting a RLC re-establishment request to the other peer entity, and
wherein causing a MAC level reset includes:
transmitting a MAC level reset request to a RRC layer of the peer entity, and
wherein the RLC re-establishment request causes the other peer entity to reset its MAC level.

15. The method of claim 10 wherein preventing the transmission of data includes:
deleting any data in a MAC layer associated with the peer entity.

16. An apparatus comprising:
a controller configured to:
determine that a RLC re-establishment with a peer entity is desirable; and
a wireless transceiver configured to:
transmit a RLC re-establishment request to the peer entity; and
wherein the controller is further configured to:
delay completion of the RLC re-establishment process for a period of time, and
complete the RLC re-establishment process.

17. The apparatus of claim 16 wherein the controller is further configured to:
delay transmitting the RLC re-establishment request until a first period of time has elapsed; and
wait a second set period of time, after transmitting the RLC re-establishment request, before completing the RLC re-establishment process.

18. The apparatus of claim 16 wherein the wireless transceiver is further configured to:
transmitting a parameter to the peer entity indicating the length of the period of time to delay before the completion of the RLC re-establishment process; and
the controller is configured to wait the indicated length of time, after transmitting the RLC re-establishment request, before completing the RLC re-establishment process.

19. The apparatus of claim 18 wherein the controller is further configured to refuse to accept data from the peer entity, unrelated to the RLC re-establishment process, between the transmitting of the RLC re-establishment request and completing the RLC re-establishment process.

20. The apparatus of claim 16 wherein the wireless transceiver is further configured to:
transmit a parameter to the peer entity indicating a time at which a RLC reestablishment acknowledgment may be transmitted from the peer entity, and
receive the RLC reestablishment acknowledgment from the peer entity; and
the controller is further configured to complete the RLC re-establishment process upon receipt of the RLC reestablishment acknowledgment from the peer entity.
